(19) United States
(12) Patent Application Publication
(10) Pub. No.: US 2005/0067917 A1
(43) Pub. Date: Mar. 31, 2005

(54) Claw pole motor

(75) Inventors: Guenter Kastinger, Gaggenau-Sulzbach (DE); Hans-Peter Dommsch, Lichtenau (DE); Eduardo Portabella, Karlsruhe (DE)

Correspondence Address: Striker Striker & Stenby, 103 East Neck Road, Huntington, NY, 11743, US

(73) Assignee: Robert Bosch GMBH, Stuttgart (DE)

(21) Appl. No.: 10/499,477

(22) PCT Filed: Jul. 31, 2003
(86) PCT No.: PCT/DE03/02571

(30) Foreign Application Priority Data
Dec. 23, 2002 (DE) 102 61 574.8

(51) Int. Cl. H02K 1/12

(52) U.S. Cl. 310/257; 310/49 A

(57) ABSTRACT

A claw pole rotor with at least one motor module is indicated, the claw pole rotor having a stator (11) and an external rotor (12). Stator (11) and rotor (12) are configured conical in shape to achieve cost and installation space advantages with the preferred use of the claw pole motor in a fan for a blower for an air conditioning system.

### BACKGROUND INFORMATION

The invention is based on a claw pole motor according to the definition of the species in claim 1.

A known, four-pole claw pole motor of this type designed as an outer rotor motor (Günter Kastinger: “Beiträge zu Ringspulenkleinantrieben”, Diss. May 2001, Johannes Kepler Universität Linz, page 8) has a hollow-cylindrical stator that is concentrically surrounded by a cylindrical rotor with an annular air gap between the two. The rotor is composed of a permanent-magnet ring magnetized in the radial direction and an iron ring serving as magnetic flux return. The stator has a cylindrical ring coil that is wound on a coil shell having an I-shaped cross section. The coil shell is slid onto a sleeve and clamped between two yokes that are pressed onto the sleeve. Two claws extend outwardly from each yoke over the ring coil, whereby the four claws, in total, interlock. The concentric ring coil mounted in the center generates a flux that creates the field in all four claws, so that a total of two pole pairs is formed. Starting at the inner sleeve, the coil flux travels across the claw poles, the air gap and the permanent magnets to the outer magnetic flux return ring. In this ring, the flux continues to flow tangentially and reconnects with the starting point via the geometrically staggered adjacent claws. In the sleeve, the flux lines flow in the direction of the longitudinal axis.

### ADVANTAGES OF THE INVENTION

The claw pole motor according to the invention having the features of claim 1 has the advantage that it can be integrated very well into the interior of a device to be driven, in particular a fan wheel of a fan or blower, and therefore requires no additional installation space. Due to its conical form, it may be advantageously slid axially into the device and easily mounted on said device with its rotor, so that a separate rotor shaft can be eliminated and an axially compact design is attainable. When the claw pole motor is used, in particular, to drive the fan wheel of a fan, e.g., in a blower for an air-conditioning system, the advantages offered by the claw pole rotor may be realized in optimum fashion, because the claw pole motor makes maximum use of the space that exists anyway in the interior of the fan wheel, and does not require that changes be made to the fan dimensions. Compared to conventional fans for blowers for air conditioning systems, when a fan wheel having the same dimensions is used, a marked reduction in the overall length of the fan is attained, which is now determined only by the axial width or depth of the fan wheel. If the structure of the fan wheel is modified slightly, it can be used simultaneously to cool the claw pole motor, so that the claw pole motor can be designed to be more powerful yet have the same dimensions.

Advantageous further developments and improvements of the claw pole motor indicated in claim 1 are made possible by the measures listed in claims 2 through 10.

A fan with integrated claw pole motor is indicated in claims 11 through 14.

A particularly space-saving twin fan for a blower for an air conditioning system may be attained with the features of claim 15.

### DRAWING

The invention is explained in greater detail in the description hereinbelow with reference to the drawing.

FIG. 1 is a perspective depiction of a claw pole motor, partially cut away, schematically depicted,

FIG. 2 is an exploded view of a fan with integrated claw pole motor,

FIG. 3 is a perspective depiction of a twin fan for a blower for an air conditioning system,

FIG. 4 is a longitudinal sectional view of the twin fan in FIG. 3.

### DETAILED DESCRIPTION OF THE EMBODIMENTS

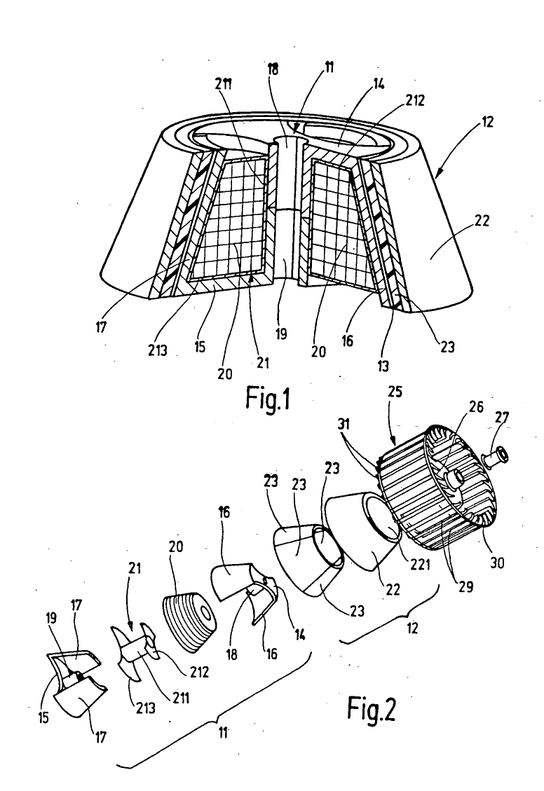

The claw pole motor—shown in an exploded view in FIG. 2 and assembled in FIG. 1, partially cut away, schematically depicted—has a stator 11 and a rotor 12 situated coaxially thereto, the rotor surrounding stator 11 with an air gap 13 between the two. Stator 11 and rotor 12 form a motor module having a conical shape, whereby the outer diameter of stator 11 and the inner and outer diameter of rotor 12 taper continually in the axial direction. It is understood that the conical shape of stator 11 and rotor 12 must not extend strictly in a straight line, but that they can also deviate therefrom. For example, the conical shape and/or outer shape can be arched outwardly or inwardly. It is also possible that the outer shapes of stator 11 and rotor 12 taper in a stepwise, corresponding manner.

Stator 11 includes two axially separated yokes 14, 15 with integral claw poles 16 and/or 17 and an integral, central sleeve 18 and/or 19 for slipping on and securing yoke 14 and/or 15 to an axis to be described hereinbelow, and a conical ring coil 20 located between yokes 14, 15. As an alternative, ring coil 20 can also be cylindrically wound, if adequate installation space is available given the specified power of the motor and if the motor can be designed less compact in size. Yokes 14, 15 with claws 16, 17 and sleeves 18, 19 are fabricated out of magnetically conductive material. Ring coil 20 is wound on a coil shell 21 that includes a central, hollow-cylindrical core 211 for sliding onto sleeves 18, 19 of yokes 14, 15, and two radial flanges 212 and 213 that limit core 211 on the end faces of core 211, the shape of each of the radial flanges designed to match the shape of adjacent yoke 14, 15. In the claw pole motor having a four-pole configuration as an example, each yoke 14 and/or 15 carries two diametrically situated claws 16 and/or 17. The two yokes 14, 15 are joined such that they are staggered in relation to each other by 90°, so that claws 16, 17 extending over ring coil 20 interlock. To manufacture ring coil 20, coil shell 21 with radial flange 212 is slid into yoke 14 that carries claws 16, whereby core 211 of coil shell 21 slides onto sleeve 18. Coil shell 21 is then rotated by 90°, so that radial flange 212 is aligned with yoke 14. Yoke 15 that carries claws 17 is then slid, with its sleeve 19, into core 211 of coil shell 21 in such a manner that claws 17 come to rest between claws 16. The winding wire is then wound onto coil shell 21, thereby producing conical ring coil 20.

In the exemplary embodiment, outer rotor 12 includes a conical magnetic flux return ring 22 that concentrically surrounds stator 11, and a number of permanent-magnet poles 23—four permanent-magnet poles 23 in the exemplary embodiment—that corresponds to the number of claws 16, 17, the permanent-magnet poles bearing against inner wall 221 of magnetic flux return ring 23 facing toward claws 16, 17. As shown in FIG. 2, permanent-magnet poles 23 are formed by permanent-magnetic shell segments that are joined in the circumferential direction to form a hollow cone. Each of the shell segments is radially magnetized, with adjacent shell segments having opposing directions of magnetization. As an alternative, permanent-magnet poles 23 can also be realized using a closed, conical permanent-magnet ring that is magnetized accordingly. In a modified embodiment, magnetic flux return ring 23 can be eliminated. The permanent-magnet shells are then magnetized in a pole-oriented manner.

In the single-strand embodiment of claw pole motor depicted in FIG. 1, it is advantageous to design claws 16, 17 to be asymmetrical, to ensure a defined start-up of the claw pole motor. Ring coil 20 is driven in a bipolar manner. If a unipolar driving of ring coil 20 is desired, then ring coil 20 is composed of two windings that are wound in the opposite direction, the windings being wound on coil shell 21.

The single-strand claw pole motor described herein can also be designed with a multiple-strand configuration, e.g., a two or three-strand configuration having any number of strands, by situating a number of motor modules corresponding to the number of strands—the motor modules being composed of stator 11 and rotor 12, as shown in FIG. 1—behind each other in the axial direction. In this case, stators 11 in the adjacent motor modules are staggered in relation to each other; in fact, when two motor modules are involved, they are staggered by 90 electrical degrees, and when m>2 motor modules are involved, they are staggered by 360 electrical degrees/m. Rotors 12 are coupled with each other in torsion-proof fashion. An axial clearance between the individual motor modules ensures magnetic decoupling. As an alternative, instead of stators 11, rotors 12 carrying permanent-magnet poles 23 can be staggered in relation to each other by the stated angle of rotation.

The claw pole motor described is used preferably as a drive motor for a fan wheel 25 of a fan configured as a radial fan or an axial-diagonal fan. A fan configured as a radial fan is shown in a perspective view in FIG. 2. The claw pole motor is situated in the interior of fan wheel 25, so that it does not require any additional installation space in the fan. Fan wheel 25 according to FIG. 2, which is shown in the right half of FIG. 4 in a sectional view, has a dish-shaped hub 26 with a conical dish wall 262 and an annular opening edge 261 that surrounds dish opening 263. Hub 26 is rotationally supported on a fan axis 28 by a bearing 27 (FIG. 4). Fan vanes 29 extend from opening edge 261 of hub 26 parallel to fan axis 28 past dish wall 262. Fan vanes 29 are stiffened by a circumferential ring 30 on their exposed end furthest from dish opening 263.

To install the claw pole motor in the fan wheel 25, rotor 12 is inserted into hub 26 and secured against the inner surface of conical dish wall 262. Fan wheel 25 is manufactured as a plastic injection-molded part, whereby the permanent magnet and, if available, magnetic flux return ring 22, are advantageously formed in hub 26 via injection molding at the same time, using the two-component injection-molding method. This results in a substantial advantage in terms of cost and installation space. Stator 12 is slid with the two central sleeves 18, 19 on yokes 14, 15 onto fixed fan axis 28 and secured thereto. Fan blades 31 are evenly distributed around the circumference on the opening edge 261 of dish-shaped hub 26, the fan blades serving to cool the claw pole motor.

With a two-strand configuration of the claw pole motor, two motor modules that are situated axially behind each other, each of which is composed of a stator 11 and a rotor 12 as described, are inserted into fan wheel 25. The motor modules are sized in such a manner that they adapt to the conical shape of hub 26. As a result, the conical motor module in the front—relative to the direction of insertion into hub 26—has a smaller diameter than the rear conical motor module. The axial length of the motor modules is adjusted accordingly to make the torque produced by the two motor modules the same.

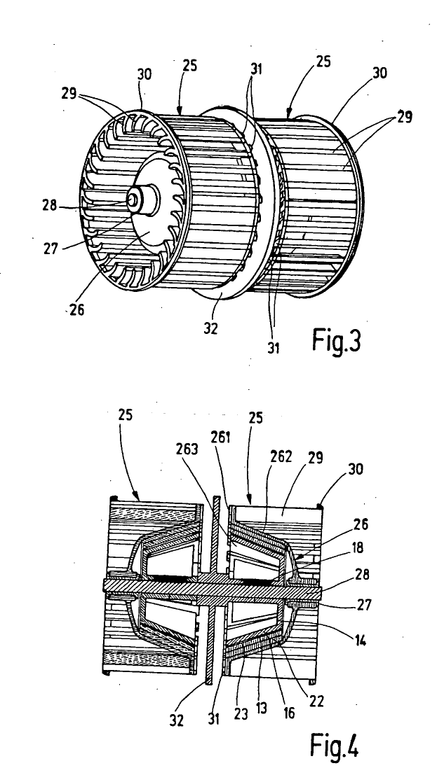

A fan configured as a twin fan, which is used preferably for blowers for air conditioning systems, is shown in a perspective view in FIG. 3. In this case, two identical fans of the type described hereinabove are situated on a common fan axis 28 with axial clearance in such a manner that the opening edges 261 of dish-shaped hubs 26 of fan wheels 25 face toward each other. Corresponding components are labeled with the same reference numerals. A mounting plate 32 is situated between the separated fan wheels 25, to which the common fan axis 28 is secured. Mounting plate 32 serves to fasten the twin fan in the blower for the air conditioning system and to accommodate electronics for motor control.

In the depicted exemplary embodiment of the twin fan, one motor module is inserted in each fan wheel 26, so that each fan wheel 26 is therefore driven by a single-strand claw pole motor. In this case, a two-stranded design of the motor arrangement—with the advantage of defined start-up—may be easily achieved by staggering stators 11 of the two motor modules in relation to each other by 90 electrical degrees, and by coupling the two rotors 12 with each other in torsion-proof fashion. As an alternative, stators 11 can also remain oriented in the same direction relative to each other, of course, and the two fan wheels 26 can be staggered in relation to each other by 90° before they are rigidly connected with each other.

1. A claw pole motor with at least one motor module that comprises a stator (11) and an external rotor (12) that are positioned concentrically to each other with an air gap (13) left between them,
wherein stator (11) and rotor (12) are conical in shape.

2. The claw pole motor as recited in claim 1,
wherein the stator (11) includes two axially separated yokes (14, 15), a preferably conical ring coil (20), and a number of interlocking claws (16, 17) extending over the ring coil (20), each half of the claws extending from one of the yokes (14, 15), preferably integral therewith, and
wherein the rotor (12) enclosing the stator (11) includes a number of permanent-magnet poles (23) that corresponds to the number of claws (16, 17).

3. The claw pole motor as recited in claim 2, wherein the ring coil (20) is wound on a coil shell (21) that includes a central, hollow-cylindrical core (211) and two radial flanges (212, 213) limiting the core (211) on the end face, the shape of which is designed to match the shape of the particular adjacent yoke (14, 15).

4. The claw pole motor as recited in claim 2, wherein the ring coil (20) is composed of two windings wound in opposing directions.

5. The claw pole motor as recited in claim 2, wherein yokes (14, 15) and claws (16, 17) are composed of magnetically conductive material.

6. The claw pole motor as recited in claim 2,
wherein the permanent-magnet poles (23) are formed of permanent magnetic, radially magnetized shell segments that are joined to form a cone.

7. The claw pole motor as recited in claim 2, wherein the rotor (12) includes a conical magnetic flux return ring (22) concentrically surrounding the stator (11); the permanent-magnet poles (23) bear against the inner wall (221) of said magnetic flux return ring facing toward the claws (16, 17).

8. The claw pole motor as recited in claim 1, wherein a number m, with m>2, motor modules with aligned module axes are situated behind each other, and
wherein the stators (11) or rotors (12) of adjacent motor modules are staggered in relation to each other by 360 electrical degrees/m, and the rotors (12) are rigidly coupled with each other.

9. The claw pole motor as recited in claim 1, wherein two motor modules with aligned module axes are situated behind each other, and
wherein the stators (11) or rotors (12) of adjacent motor modules are staggered in relation to each other by 90 electrical degrees, and the rotors (12) are rigidly coupled with each other.

10. The claw pole motor as recited in claim 1, characterized by its use in fan that includes a fan wheel (25) with fan vanes (29), in which the claw pole motor is situated in the interior of the fan wheel (25).

11. A fan with a fan wheel (25) carrying fan vanes (29), characterized by a claw pole motor as recited in claim 1 situated in the interior of the fan wheel (25).

12. The fan as recited in claim 11,
wherein the fan wheel (25) includes a dish-shaped hub (26) with conical dish wall (262), the hub being rotationally supported on a fan axis (28), and
wherein the stator (11) is mounted on the fan axis (28) in torsion-proof fashion, and the rotor (12) is secured to the hub (26).

13. The fan as recited in claim 12,
wherein the yoke (14, 15) carrying the claws (16, 17) is mounted on the fan axis (28) in torsion-proof fashion, and the coil shell (21) accommodating the ring coil (20) is mounted in torsion-proof fashion on central sleeves (18, 19) extending away from the yokes (14, 15), and
wherein the permanent-magnet poles (23) bear, in torsion-proof fashion-via the magnetic flux return ring (22), if necessary-against the conical dish wall (262) of hub (26), preferably injection-molded in the hub (26), together with the magnetic flux return ring (22), if necessary.

14. The fan as recited in claim 12,
wherein the fan vanes (29) extend from the opening edge (261) of the dish-shaped hub (26) past the hub (26), parallel to the fan axis (28), and
wherein fan blades (31) are situated on the opening edge (261) of the hub (26) to ventilate the claw pole motor.

15. A twin fan, in particular for air conditioning systems, characterized by two fans as recited in claim 11, which are positioned—with fan axes integrally joined to a common fan axis (28)—axially relative to each other with clearance in such a manner that the opening edges (221) of the dish-shaped hubs (26) of the fan wheels (25) face toward each other, and that a mounting plate (32) extending radially between the fan wheels (25) accommodates the common fan axis (28) in torsion-proof fashion.

16. The twin fan as recited in claim 15,
wherein the stators (11) of the claw pole motors located in the interior of the two fan wheels (25) are staggered in relation to each other by 90 electrical degrees around the fan axis (28), and the fan wheels (25) are rigidly coupled with each other with rotors (12) oriented in the same direction.
